(19) United States
(12) Patent Application Publication
(10) Pub. No.: US 2008/0250880 A1
(43) Pub. Date: Oct. 16, 2008

(54) Device and Method for Washing Samples in an Analysis Apparatus

(75) Inventors: Giacinto Zilioli, Rodano (MI) (IT); Luigi Ragaglia, Rodano (MI) (IT)

Correspondence Address: NIXON & VANDERHYE, PC, 901 NORTH GLEBE ROAD, 11TH FLOOR, ARLINGTON, VA, 22203, US

(73) Assignee: THERMO ELECTRON S.P.A., Rodano (MI) (IT)

(21) Appl. No.: 11/596,858

(22) PCT Filed: May 18, 2005
(86) PCT No.: PCT/IB05/01340

§ 371 Date: Nov. 17, 2006

(30) Foreign Application Priority Data
May 26, 2004 (IT) MI2004 A 001062

(51) Int. Cl. G01N 1/00

(52) U.S. Cl. 73/864.81

(57) ABSTRACT

The present invention relates to a device for washing samples that are intended to be introduced in an analysis apparatus, particularly for elemental analysis, which has a chamber sized such as to house only one sample at a time, means for feeding the samples, from a condition in contact with the ambient atmosphere, one at a time to said chamber, means for closing said sample-containing chamber relative to the environment, means for feeding and releasing a washing gas to and from said chamber, and means for opening this chamber to the analysis apparatus in sealed conditions relative to the atmosphere.

### FIELD OF THE INVENTION

The present invention relates to a device and method for washing samples that are intended to be introduced in an apparatus for chemical analysis. Such a washing device is particularly, though not exclusively, intended for the treatment of samples to be used with organic elemental analysis apparatuses.

With this type of analysis, the sample to be analysed must be necessarily free of any nitrogen contribution from the environment, which otherwise would be added to the sample content, particularly when wishing to evaluate the presence of traces of nitrogen and the isotopic ratios.

The samples to be analysed are housed, in solid form, in a sampling system by which they are introduced in the analytic system, one at a time, and at the right moment. The sampling system further provides for washing the atmospheric nitrogen off each sample.

### DESCRIPTION OF THE PRIOR ART

Basically, it is known to use two sampling systems for this purpose. With the first known sampling system, which is called open, the sample is housed in a chamber open to the air, where atmospheric nitrogen is washed off the sample by means of a stream of washing gas, usually inert gas and generally helium.

The second known sampling system, which is called sealed, consists of an environment which can be set tightly sealed from the atmosphere and can be directly connected to the analyzer. All the samples to be analyzed are sequentially placed in this environment. When the samples have been loaded, the environment is closed and washed inside, the air that may be contained therein being removed and replaced by the washing gas, then the samples are fed to the analyzer, one at a time by maintaining the sealed conditions relative to the atmosphere.

The washing operation with this second type of sampling system, though effective, is a slow operation, due to the great number of involved samples and must be also repeated each time new samples to be analyzed are to be added.

It is understood that the open sampling method cannot ensure complete removal of atmospheric nitrogen, whereas the sealed sampling method is more effective for abating any contribution of ambient nitrogen to the samples to be analyzed, but it is also known that the addition of samples to be analyzed requires long conditioning times which impair productivity.

### OBJECTS OF THE INVENTION

Having said this, the object of the present invention is now to conjugate the versatility of a sampling system where the samples can be housed in the air, with the washing efficacy of a sealed sampling system.

### SUMMARY OF THE INVENTION

In order to achieve these and other objects, there is provided according to the invention a washing device having the characteristics stated in claim 1, as well as a method such as indicated in claim 16.

The device of this invention essentially consists of a tightly sealed small chamber, which is suitable to contain only one sample at a time and is used to receive the sample to be analyzed, provides for carrying out the washing both of the sample and the chamber in order to eliminate any contribution of ambient nitrogen, and provides for inserting the samples in the analysing apparatus without any contact occurring with the atmosphere, preferably without creating any perturbation to the stream and/or pressure of the analytic system.

This device can be interposed between a traditional sampling system of the open type and the analyser, so that the addition of new samples can be made very simple and fast, while the device of the invention carries out the cleaning of the sample and the abatement of the nitrogen contribution from the environment.

The sample washing device according to the invention consists of a set of mechanical and electrical parts allowing this device to operate in synchronization with the analysis apparatus and the sampling system, a series of solutions being further provided for the sample to be prepared in a washing chamber that is completely isolated from the environment, with washing gas lines that, by maintaining therein a higher pressure than the atmospheric pressure, do not permit that the air may be diffused to the analysis system.

### DESCRIPTION OF THE PREFERRED EMBODIMENT

The invention will be described more in detail with reference to a preferred, though not exclusive, embodiment of the same, which is schematically illustrated in the annexed drawings, in which:

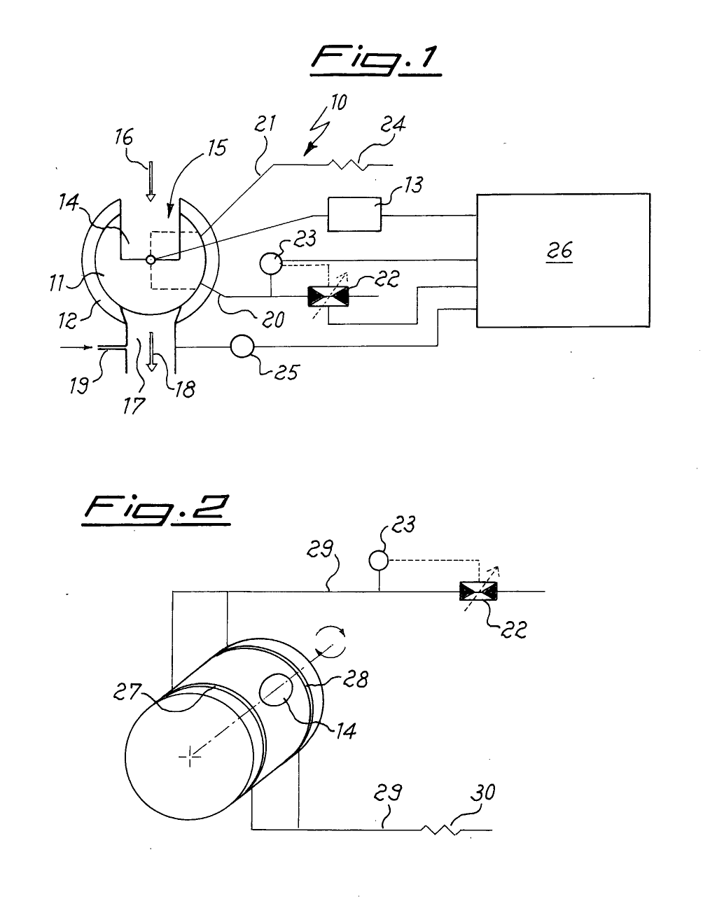

FIG. 1 is a diagram of said embodiment of the device being connected to an analytic system.

FIG. 2 is a diagram of the means participating in sealing the device from the environment.

With reference to the drawings, the illustrated embodiment of device 10 comprises a cylindrical block 11 that is sealingly inserted in an outer enclosure 12, also cylindrical, a material being interposed therebetween which is capable of providing a seal.

The outer enclosure 12 is hold stationary, whereas the block 11 is rotatably mounted about its axis and is driven by a motor 13.

In the block 11 a small chamber 14 is formed, which is capable of receiving only one sample at a time and has a port leading to the side surface of the block 11. The chamber 14 has a volume less than 5 cm³, normally of 1 cm³, it can have a volume of about 1 cm³ or less.

The outer enclosure 12 is provided, in turn, with two ports, the first 15 of which faces a sample feeding system, in contact with the atmosphere, for example a known open system, or any other system capable of feeding at will a sample at a time to the little chamber 14, with a desired timing, when the latter is aligned with port 15. This system is outlined in FIG. 1 by the arrow 16. The other port 17 of the outer enclosure 12 is in communication with the analytic system, such as indicated by the arrow 18. This communication is carried out in a sealed manner from the environment, also due to feeding a carrier gas 19 at higher pressure than the atmospheric one.

Again in the outer enclosure 12, there are provided two ducts, 20 and 21, respectively, which pass there through and lead to the inner surface thereof, i.e. the outer surface of block 11. The duct 20 is fed with a washing gas, such as indicated in 22, at controlled pressure in 23, whereas the duct 21 leads to the atmosphere downstream of a bottleneck 24 capable of maintaining the desired pressure within the device.

The rotations of block 11 under control of motor 13 cause the small chamber 14 to rotate in three different positions, where it stops for the time required. The first position is illustrated with a solid line in FIG. 1 and coincides with the alignment of the port of small chamber 14 with the port 15 of the enclosure, for a sample to be introduced in the small chamber. The second position, for example at 90° from the first one, is illustrated with a dotted line in FIG. 1. In this position, the port of the small chamber 14 is sealingly closed from the port 15, but it is pneumatically connected with both ducts 20 and 21 to permit the washing of the small chamber 14 and the sample contained therein. The washing gas can be an inert gas, as is common, or it may be also oxygen in the case of elemental analysis.

When the washing has been completed, the block 11 is rotated by further 90°, for example, until the port of the little chamber 14 is aligned with the port 17 of the enclosure, in order to send the washed sample to the analytic system. Then, the block 11 is returned to its starting position.

It should be noted that not only the washing is very effective, as it is carried out on one single sample in a chamber of a reduced volume that is perfectly sealed from the atmosphere, but it is also very fast and hence it does not affect the system productivity in a negative manner.

A pressure detector 25 transmits the pressure value as detected at the inlet of the analysis apparatus to an electronic control system 26, which electronic control system 26 controls the delivery of the washing gas to 22 and 23, at a pressure related with, and preferably equal to, that detected in 25, which is however always higher than the atmospheric pressure.

This overcomes the drawbacks created by those sampling systems where the sample is dropped in the analytic system, which create a perturbation in the system due to the fact that the pressures in the analytic system and in the chamber containing the sample require to be balanced. On the contrary, the illustrated device automatically controls that the washing pressure is the same as the analytic system operating pressure, such that the system is not disturbed when the sample is introduced, thereby providing ideal stability for the analytic system.

The electronic control system 26, besides adjusting the washing gas pressure, is also arranged for positioning the chamber 11 in the three positions above, in synchronism with the sampler 16 and analytic system 18. In order to best ensure the sealing from the atmosphere in the whole device, the block 11 is provided with channels or grooves 27, 28 (FIG. 2), for example circumferential, on two sides of the small chamber 14 port and of ports 15 and 17. These grooves 27 and 28 are fed by a duct 29 sending washing gas at higher pressure than the atmospheric one, for example at the same pressure as controlled in 22 and 23, which gas is then released through a duct 29 with a bottleneck 30. Thereby, any infiltration of the atmospheric air at the cylindrical interface between the block 11 and outer enclosure 12 is avoided.

It should be noted that the embodiment illustrated above has been provided only by way of example, and a number of variations can be applied to the same. In particular, the chamber 14 can be provided either in a stationary position, or linearly movable with spool moving elements controlling the openings thereof. Furthermore, the sealing grooves 27 and 28 may be positioned in different areas or additional sealing grooves may be provided. Finally, though reference has been made to an apparatus for organic elemental analysis, the device according to the invention can be provided for washing samples intended for other chemical analysis apparatuses.

1. A device for washing samples intended to be introduced in an analysis apparatus, characterized by a chamber sized such as to house only one sample at a time, means for feeding the samples, from a condition in contact with the ambient atmosphere, one at a time to said chamber, means for closing said sample-containing chamber relative to the environment, means for feeding and releasing a washing gas to and from said chamber, and means for opening this chamber to the analysis apparatus in sealed conditions relative to the atmosphere.

2. The device according to claim 1, characterized in that said chamber has a volume of about 5 cm³ or less.

3. The device according to claim 1, characterized in that the means for feeding and releasing the washing gas to and from said chamber maintain a pressure higher than the atmospheric one within said chamber.

4. The device according to claim 3, characterized in that it comprises means for adjusting the pressure of the washing gas within said chamber.

5. The device according to claim 4, characterized in that it comprises an electronic control for adjusting the pressure of the washing gas in said chamber as a function of the pressure in the analysis apparatus.

6. The device according to claim 3, characterized in that said means for releasing the washing gas comprise a restriction acting on the outlet gas stream.

7. The device according to claim 1, characterized in that it is interposed between an analysis apparatus and a sampling system open to the ambient atmosphere.

8. The device according to claim 1, characterized in that said chamber is in a stationary position and comprises tightly sealed opening/closing means.

9. The device according to claim 1, characterized in that said chamber is made in a block sealingly movable between a sample-receiving position, a washing position and a position in which the sample is sent to the analysis apparatus.

10. The device according to claim 8, characterized in that it comprises at least one washing gas feed duct and at least one washing gas release duct, which lead to said chamber when the same is sealed from the atmosphere.

11. The device according to claim 9, characterized in that said block is a cylindrical element driven in sealed rotation in a corresponding outer housing, said chamber being formed in the block and having a port on the side wall thereof.

12. The device according to claim 11, characterized in that said block is driven in rotation by a motor, which is, in turn, electronically controlled in synchronism with the analysis apparatus, and optionally with the sampling system, between a sample-receiving position, an intermediate washing position and a position in which the sample is sent to the analysis apparatus.

13. The device according to claim 12, characterized in that at least one washing gas feed duct and at least one washing gas release duct cross the outer housing of the block and lead to the chamber when the latter is in the intermediate washing position.

14. The device according to claim 8, characterized in that it comprises grooves on the block surface, which are fed with washing gas at higher pressure than the atmospheric one.

15. The device according to claim 11, characterized in that said grooves comprise at least circumferential grooves provided on two sides of the chamber port, in the side wall of the rotating cylindrical block.

16. A sampling method for an analysis apparatus, characterized in that one sample at a time is introduced in a chamber suitable to contain only one sample, this chamber is sealingly closed from atmosphere, washing gas is fed at higher pressure than the atmospheric one to this sealingly closed chamber and the gas is released through a restriction, the chamber is opened to the analysis apparatus by maintaining the sealing from the atmosphere.

17. The method according to claim 16, characterized in that the pressure of the washing gas is controlled as a function of the pressure existing within the analysis apparatus at the time when the sample is introduced in this apparatus.

18. The method according to claim 16, characterized in that the operating steps of the method are time-controlled in synchronism with the analysis apparatus and optionally with a sampling system being located upstream.
